(19) United States
(12) Patent Application Publication
(10) Pub. No.: US 2026/0109402 A1
(43) Pub. Date: Apr. 23, 2026

(54) VEHICULAR TRAILER ASSIST SYSTEM WITH DETERMINATION OF TRAILER ANGLE

(71) Applicant: Magna Electronics Inc., Auburn Hills, MI (US)

(72) Inventors: Jyothi P. Gali, Rochester Hills, MI (US); Prasanna Ananthakrishnan, Tamilnadu (IN); Milan Sharma, Brampton (CA); Sharad Benakatti, Bangalore (IN)

(21) Appl. No.: 19/361,194

(22) Filed: Oct. 17, 2025

Related U.S. Application Data
(60) Provisional application No. 63/709,611, filed on Oct. 21, 2024.

(51) Int. Cl. B62D 13/06; B62D 15/02

(52) U.S. Cl. CPC B62D 13/06; B62D 15/0245

(57) ABSTRACT

A vehicular trailering assist system of a vehicle includes a camera. The system determines a reference point at the vehicle that corresponds to a pivot axis of a trailer hitched to the vehicle. The system, using the camera, (i) determines location of a first target at the trailer and (ii) determines location of a second target at the trailer. The system, during a calibration maneuver, (i) determines a first offset based on the reference point and the location of the first target and (ii) determines a second offset based on the reference point and the location of the second target. The system determines a triangle based on (i) the reference point at the vehicle, (ii) the location of the first target and (iii) the location of the second target. The system, after completion of the calibration maneuver, determines a trailer angle of the trailer relative to the vehicle.

### CROSS REFERENCE TO RELATED APPLICATION

The present application claims the filing benefits of U.S. provisional application Ser. No. 63/709,611, filed Oct. 21, 2024, which is hereby incorporated herein by reference in its entirety.

### FIELD OF THE INVENTION

The present invention relates generally to a vehicular trailering assist system for a vehicle and, more particularly, to a vehicular trailering assist system that utilizes one or more cameras at a vehicle.

### BACKGROUND OF THE INVENTION

Use of imaging sensors in vehicular trailer assist systems is common and known. Examples of such known systems are described in U.S. Pat. Nos. 9,446,713 and 9,085,261, which are hereby incorporated herein by reference in their entireties.

### SUMMARY OF THE INVENTION

A vehicular trailering assist system includes a camera disposed at a vehicle equipped with the vehicular trailering assist system. The camera views exterior of the equipped vehicle, and, with a trailer hitched to the equipped vehicle, the camera views at least a portion of the trailer hitched to the equipped vehicle. The camera is operable to capture image data. The system includes an electronic control unit (ECU) with electronic circuitry and associated software. Image data captured by the camera is transferred to the ECU. The electronic circuitry of the ECU includes an image processor for processing image data captured by the camera and transferred to the ECE. The vehicular trailering assist system determines a reference point at the equipped vehicle that corresponds to a pivot axis of the trailer hitched to the equipped vehicle. The vehicular trailering assist system, via processing at the ECU of image data captured by the camera, (i) determines location of a first target disposed at the trailer and (ii) determines location of a second target disposed at the trailer. The vehicular trailering assist system, during a calibration maneuver of the equipped vehicle, (i) determines a first offset based on the location of the reference point at the equipped vehicle and the determined location of the first target and (ii) determines a second offset based on the location of the reference point at the equipped vehicle and the determined location of the second target. The vehicular trailering assist system determines a triangle based on (i) the reference point at the equipped vehicle, (ii) the determined location of the first target and (iii) the determined location of the second target. The vehicular trailering assist system, after completion of the calibration maneuver of the equipped vehicle, determines a trailer angle of the trailer relative to the equipped vehicle based at least on (i) the determined triangle, (ii) the determined first offset and (iii) the determined second offset.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a trailering assist system that is operable to determine a trailer angle of a trailer relative to a towing vehicle in accordance with the present invention;

FIG. 2 is a block diagram of the trailering assist system of FIG. 1;

FIGS. 3A-3C are exemplary images of trailers affixed with targets;

FIGS. 4A-4C are images of exemplary triangles based on targets affixed to a trailer;

FIG. 5 is a schematic view of a left offset and a right offset of a triangle based on targets affixed to a trailer;

FIGS. 6A and 6B are schematic views of a trailer angle of a trailer based on a triangle;

FIG. 7 is an image of a trailer where only a single target is visible; and

FIG. 8 is a schematic view of an angle of a triangle based on targets affixed to a trailer.

### DESCRIPTION OF THE PREFERRED EMBODIMENTS

The implementation of vision-based tracking for gooseneck and fifth wheel trailers improves the functionality of trailer backup assistant systems and/or vehicular trailering assist systems. Some sensors used to determine a trailer angle of a trailer with respect to a towing vehicle equipped with the sensors may be expensive and are susceptible to performance degradation due to environmental conditions. To address these limitations, implementations herein include a camera-based system that determines the trailer angle relative to the towing vehicle. This trailer angle is utilized to plan the vehicle's trajectory during the operation of the trailering assist system.

A vehicle and trailer maneuvering system or trailering assist system or trailer backup system and/or driving assist system operates to capture images exterior of the vehicle and trailer being towed by the vehicle and may process the captured image data to determine a path of travel for the vehicle and trailer and to detect objects at or near the vehicle and in the predicted path of the vehicle, such as to assist a driver of the vehicle in maneuvering the vehicle and trailer in a rearward direction. The system includes an image processor or image processing system that is operable to receive image data from one or more cameras and may provide an output to a display device for displaying images representative of the captured image data. Optionally, the system may provide a rearview display or a top down or bird's eye or surround view display or the like.

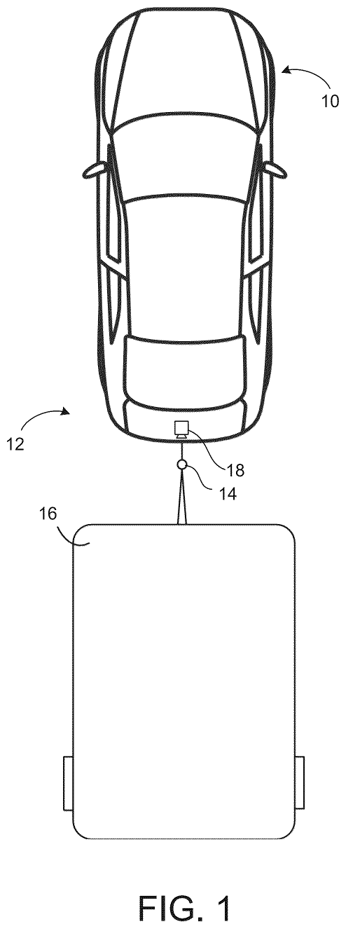

Referring now to the drawings and the illustrative embodiments depicted therein, a vehicle 10 includes a trailering assist system 12 that is operable to assist in backing up or reversing with a hitched trailer via, for example, a hitch 14 and may maneuver the vehicle 10 and trailer 16 toward a desired or selected location. The trailering assist system 12 includes at least one exterior viewing vehicle-based imaging sensor or camera, such as a rearward viewing imaging sensor or camera 18 (and the system may optionally include multiple exterior viewing imaging sensors or cameras, such as a sideward/rearward viewing camera at respective sides of the vehicle), which captures image data representative of the scene exterior of the vehicle 10, which includes the hitch 14 and/or trailer 16, with the camera 18 having a lens for focusing images at or onto an imaging array or imaging plane or imager of the camera (FIG. 1). Optionally, the camera is a center-high-mounted stop lamp (CHMSL) camera. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The trailer maneuver assist system 12 includes a control or electronic control unit (ECU) or processor that is operable to process image data captured by the camera or cameras and may detect objects or the like and/or provide displayed images at a display device for viewing by the driver of the vehicle (the control and/or display device may be part of or incorporated in or at an interior rearview mirror assembly of the vehicle, or the control and/or the display device may be disposed elsewhere at or in the vehicle). The data transfer or signal communication from the camera to the ECU may comprise any suitable data or communication link, such as a vehicle network bus or the like of the equipped vehicle.

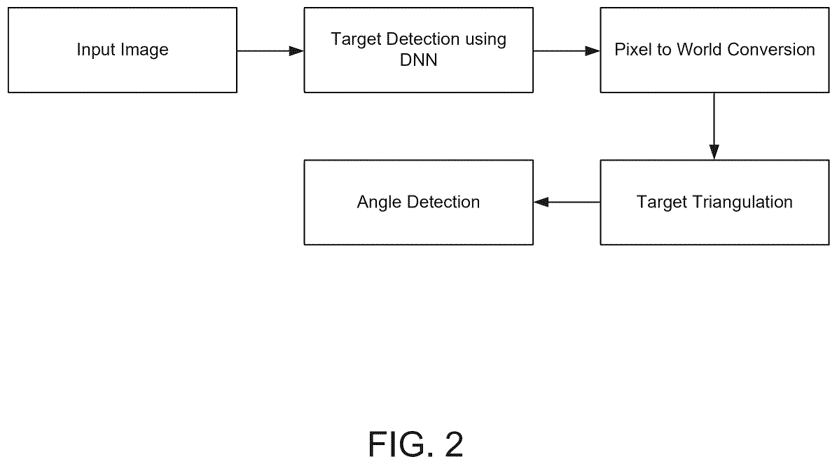

Referring now to FIG. 2, to facilitate the trailering assist system, especially for non-conventional trailers (e.g., fifth wheels and gooseneck trailers), stickers or decals or markers or targets are strategically placed at corners of a front end of the trailer, such that the targets are visible to the rear camera of the towing vehicle. As used herein, a target or sticker refers to any marker or label that is affixed to a surface of the trailer to facilitate visual recognition or tracking by a camera system. This target may be applied to the trailer using various methods, including but not limited to adhesive backing, which allows the target to be easily attached and removed, direct application through painting, where the design or marker or target is painted directly onto a surface of the trailer, and magnetic attachment, where the target is made from or includes magnetic materials that enable it to adhere to metallic surfaces without the need for adhesives.

The materials used to create the targets may vary widely depending on the specific requirements of durability, visibility, and resistance to environmental conditions. Materials may include vinyl, which is durable and weather-resistant; reflective materials, which enhance visibility of the target under low-light conditions; and metallic foils, which can provide both durability and reflectivity. Additionally, targets can be made from plastic or composite materials that offer flexibility and resilience against wear and tear or degradation. Materials and application methods for the target may be determined based on factors such as an intended duration of use of the target, environmental conditions to which the target may be exposed, and specific requirements of the trailering assist system.

These targets are detected using, for example, one or more input images captured by the camera and a deep neural network (DNN), which identifies pixel coordinates of the targets. The detection process may also be achieved through various alternative methods. For instance, a convolutional neural network (CNN) or a recurrent neural network (RNN) may be used, which may be particularly effective in processing visual data and identifying patterns within images. Additionally, a support vector machine (SVM) may be used for classification tasks. Furthermore, image processing techniques, such as edge detection, color segmentation, and feature extraction, may be combined with machine learning algorithms to enhance the accuracy and efficiency of target detection.

The pixel coordinates are converted into world coordinates. The world coordinates are triangulated to determine the trailer angle accurately. That is, because the targets are located at known positions on the trailer, the relative distances and angles of the targets may be used to determine a geometric relationship between the positions of the targets in the image and the actual positions of the targets with respect to the equipped vehicle.

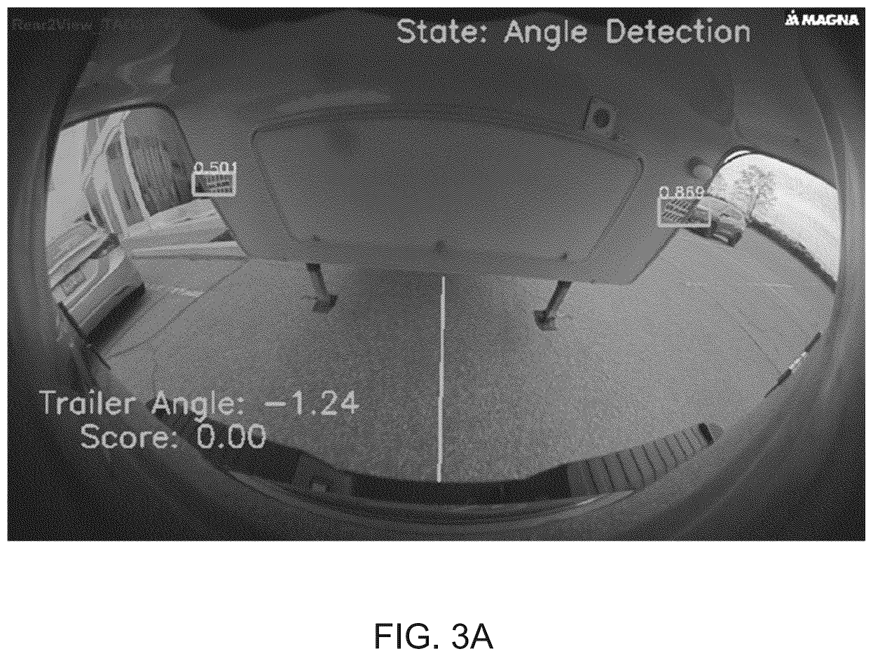

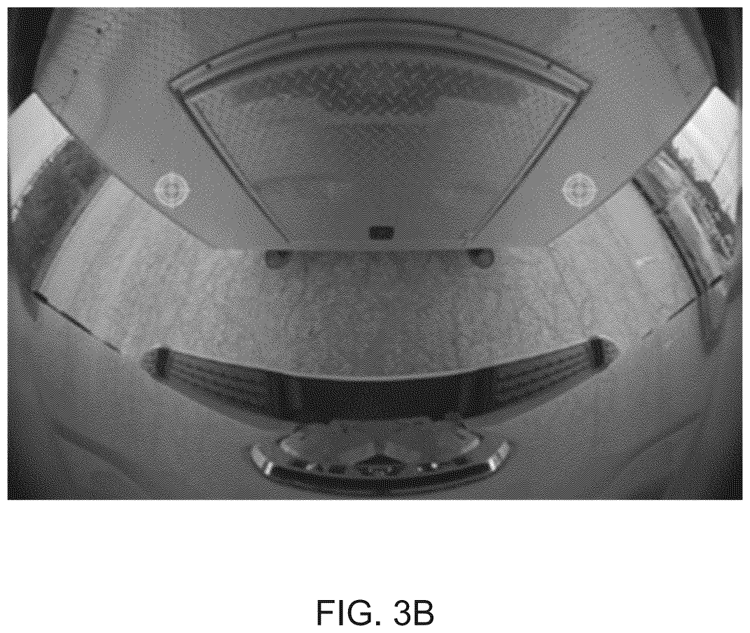

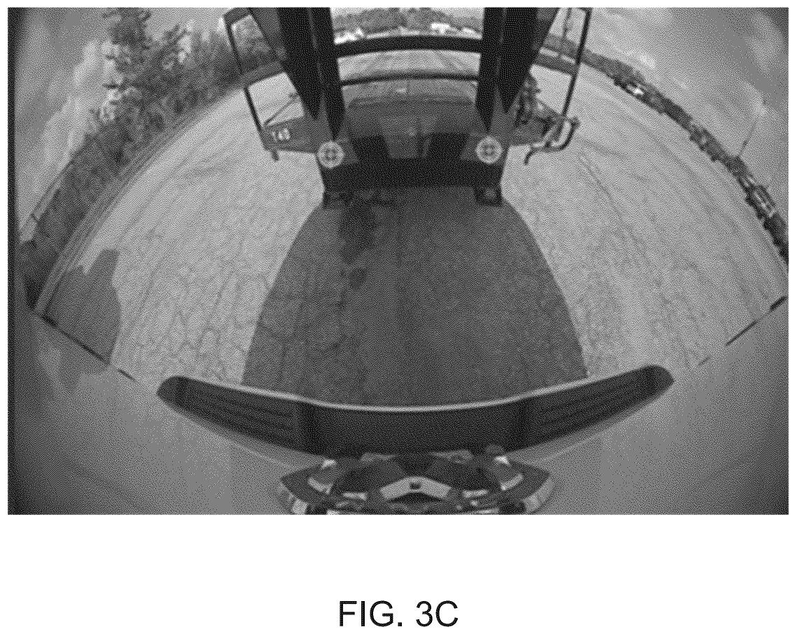

More specifically, and as shown in FIGS. 3A-3C, targets are affixed to the corners of the front section of the trailer that are within the field of view of the rear-view camera. The image (e.g., an RGB image) captured by the rear-view camera serves as the input to the DNN or other machine learning model that detects the targets and determines a bounding box location for each respective target. A centroid of each bounding box for each target may be determined, and respective pixel coordinates of the centroid may be converted into world coordinates based on a predefined reference height. Using the world coordinates, a triangle is determined with a reference point on the equipped vehicle that coincides with a pivot point of the trailer when the trailer is hitched to the equipped vehicle (e.g., a center of a rear axle of the equipped vehicle, a center of a rear bumper of the equipped vehicle, a point along a longitudinal axis of the equipped vehicle, etc.) serving as a vertex of the triangle. That is, the reference point is selected as a point on the equipped vehicle relative to which the trailer pivots when hitched to the vehicle (e.g., at a hitch location or a receiver location for the trailer that is mounted on the equipped vehicle). In examples where the trailer is a fifth-wheel trailer or a gooseneck trailer, the reference point may be a center of a rear axle of the equipped vehicle (e.g., a point along the rear axle intersecting with a longitudinal axis of the equipped vehicle) or a receiver mounted to the equipped vehicle, which serves as a pivot point of the fifth-wheel trailer or gooseneck trailer. The angle of the trailer is determined based on the configuration of the triangle.

The detection of the targets within the system pipeline is executed utilizing an end-to-end trained DNN or other machine learning model. For example, the DNN is a two-dimensional object detection (OD) network that generates bounding boxes around the targets identified in the input image. The network architecture may include a sequence of convolutional, activation, and down-sampling layers, collectively forming a backbone of the network. Following the backbone, an object detection head leverages robust high-level image feature map outputs from the backbone at various down-sampled spatial resolutions to regress the bounding box coordinates of the targets present in the input image.

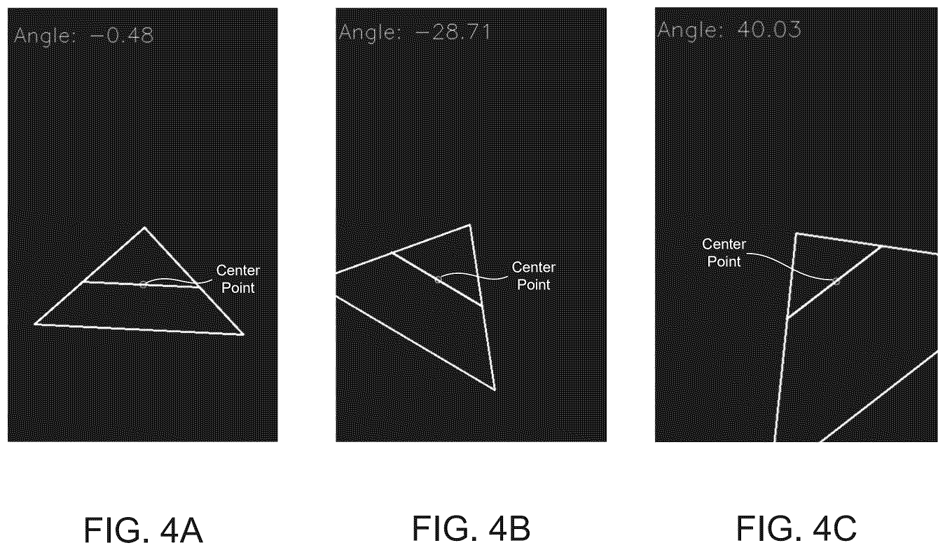

Upon the DNN generating the bounding boxes around the targets, the centroids of the bounding boxes are determined. The pixel coordinates may be converted to world coordinates based on the predefined reference height. The triangle is formed using the center of the rear axle as the pivot point of the triangle. As the trailer rotates, the triangle also rotates, representing the orientation of the trailer itself. FIGS. 4A-4C illustrate an exemplary triangle for a −0.48 degree trailer angle (FIG. 4A), a −28.71 degree trailer angle (FIG. 4B), and a 40.03 trailer angle (FIG. 4C). A center point is derived from the middle of the triangle, and the trailer angle is determined based in part on the center point.

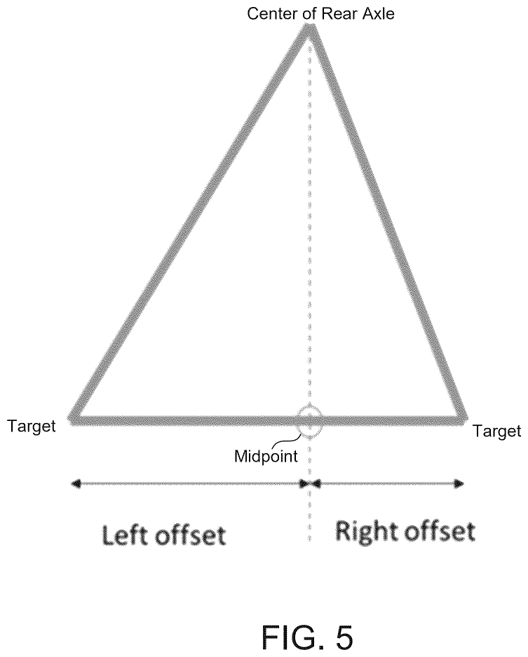

This trailering assist system may include an initial calibration phase to determine a zero-angle reference. The system performs an angle detection phase to determine the trailer angle of the trailer relative to the vehicle when the trailer is hitched to the vehicle. That is, the calibration process or phase establishes the zero-angle reference, which serves as the baseline for subsequent angle measurements. In order to account for potential asymmetrical placement of the targets on the trailer, the trailering assist system uses a calibration drive to determine and compensate for target placement errors. During the calibration drive, the user drives the vehicle in a straight line for a threshold distance. In examples where the vehicle is an autonomous vehicle or includes an advanced driver assist system (ADAS), the vehicle may perform the calibration drive responsive to input from the trailering assist system. The threshold distance may be, for example, greater than 10 meters. For example, the vehicle may travel in a straight line for at least 15-20 meters. The system may use kinematic analysis to confirm that the vehicle has traveled straight. As shown in FIG. 5, once straight-line travel is verified, offsets between the two sides of the triangle formed by the targets and the center of the rear axle (i.e., the simulated pivot point) are determined. The determined offsets are stored in a buffer. Offset determination improves the accuracy of the trailer angle detection during the angle detection phase.

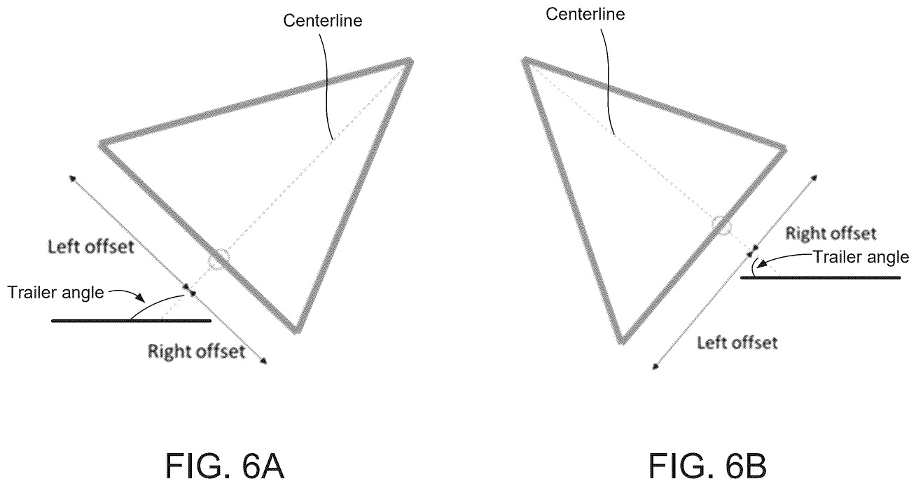

During the angle detection phase, and with the offsets of each target (i.e., a left offset and right offset or first offset and second offset) determined during the calibration drive, the system may accurately determine the trailer angle as the trailer rotates, such as during hauling of the trailer or during reverse maneuvering of the trailer. As shown in FIGS. 6A and 6B, a midpoint of the triangle, formed by the stickers, may be determined using the left and right offsets determined and stored during the calibration phase. The trailer angle, representing an angle formed between a longitudinal axis of the trailer and the rear of the vehicle, may be determined using the center of the rear axle, which functions as the pivot point of the triangle, and the determined midpoint.

The trailering assist system may determine a centerline extending between the center of the rear axle and the midpoint to represent the longitudinal axis of the trailer. That is, the centerline may extend from a point of the triangle opposite the line formed by the two targets and through the line formed by the two targets at a point based on the offsets (i.e., a point between left offset and the right offset). Additionally or alternatively, the centerline may extend through the position of the center point derived from the middle of the triangle. The offsets remain constant throughout the entire angle detection phase, ensuring consistent and reliable measurements. The trailer angle may be determined as the angle formed by the centerline and the rear of the equipped vehicle (e.g., a rear bumper of the equipped vehicle and/or the rear axle of the equipped vehicle).

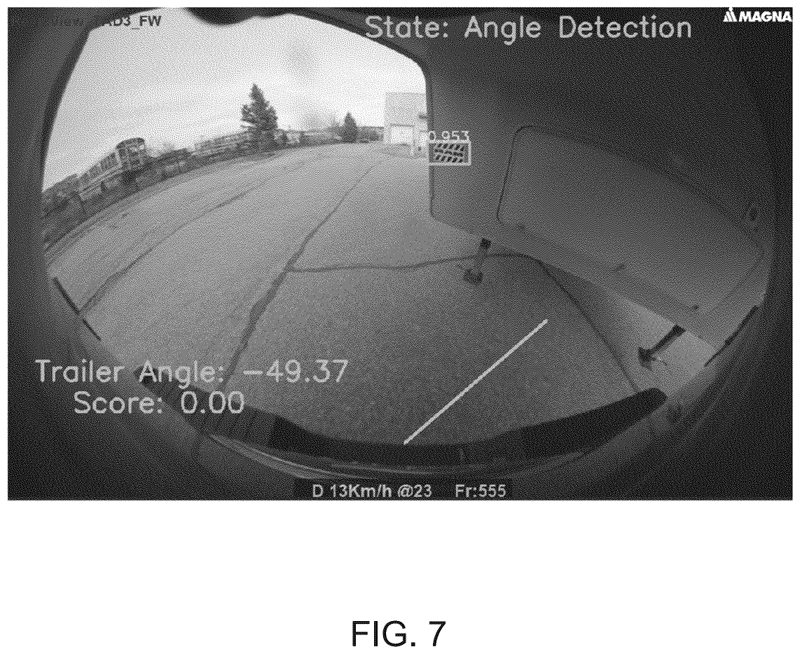

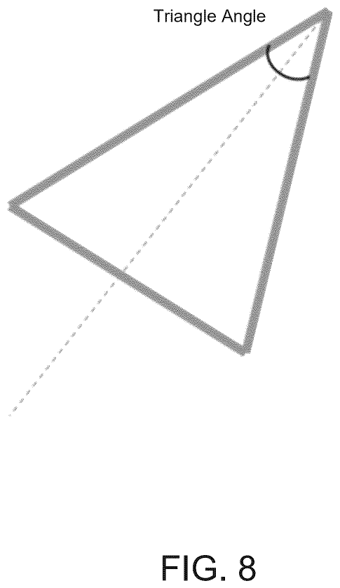

As the trailer turns, one of the targets may begin to disappear from the camera's view. For example, as shown in FIG. 7, the trailer has turned relative to the vehicle sufficiently that only one of the targets is visible within the field of view of the camera. To address this, the system stores the trailer angle from the previous frame in a buffer and uses this information to rotate the detected world coordinates to the other side (FIG. 8). That is, the system, using the angle from the previous frame of image data and based on movement of the visible target from the previous frame of image data and the current frame of image data, determines an angle for the current frame of image data. Based on the angle of the current frame of image data, the trailer angle is continuously tracked, even if only one target remains visible.

While examples herein describe using targets to determine two points of the triangles, other, pre-existing features of the trailer may be used as targets instead. That is, instead of relying on stickers or other targets placed by the user, the system may instead recognize and store identifiable features of the trailer in lieu of the placed targets, such as decorative designs, edges, corners, bolts or other fasteners, etc.

The vehicular trailering assist system may be useful in a variety of applications. For example, the system may be part of a camera-based trailer feature detection system. As another example, the system may be part of or work with an automatic trailer selection system that recognizes the trailer hitched to the vehicle based on previous calibration of the trailer.

In a further example, the trailering assist system may be used in applications in which the equipped vehicle is towing a trailer that hitches to the equipped vehicle at a receiver proximate to a rear bumper of the equipped vehicle (e.g., a bumper-pull trailer or a receiver-hitch trailer where the hitch receiver is mounted to the chassis or bumper of the vehicle and the hitch ball is disposed generally at and rearward of the bumper of the vehicle). In such examples, the center of rear bumper of the equipped vehicle (i.e., a point of the rear bumper at the longitudinal axis of the equipped vehicle) and/or a position of a hitch receiver of the equipped vehicle may serve as the pivot point of the triangle (i.e., the reference point). Optionally, the trailering assist system may have a settings feature in which the user may select whether the trailer is a fifth wheel and/or gooseneck trailer or a bumper-pull trailer. For example, the trailering assist system may pair with an infotainment system of the equipped vehicle to display the settings feature, and the trailering assist system may receive input from the user via the infotainment system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of the trailering assist systems or trailer angle detection systems or trailer hitch assist systems described in U.S. Pat. Nos. 11,787,339; 11,613,210; 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0028111; US-2022-0027644; US-2022-0024391; US-2021-0170947; US-2021-0170820; US-2021-0078634; US-2021-0053572; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a camera disposed at a vehicle equipped with the vehicular trailering assist system, wherein the camera views exterior of the equipped vehicle, and wherein, with a trailer hitched to the equipped vehicle, the camera views at least a portion of the trailer hitched to the equipped vehicle;
wherein the camera is operable to capture image data;
an electronic control unit (ECU) comprising electronic circuitry and associated software;
wherein image data captured by the camera is transferred to the ECU;
wherein the electronic circuitry of the ECU comprises an image processor for processing image data captured by the camera and transferred to the ECU;
wherein the vehicular trailering assist system determines a reference point at the equipped vehicle that corresponds to a pivot axis of the trailer hitched to the equipped vehicle;
wherein the vehicular trailering assist system, via processing at the ECU of image data captured by the camera, (i) determines location of a first target disposed at the trailer and (ii) determines location of a second target disposed at the trailer;
wherein the vehicular trailering assist system, during a calibration maneuver of the equipped vehicle, (i) determines a first offset based on the location of the reference point at the equipped vehicle and the determined location of the first target and (ii) determines a second offset based on the location of the reference point at the equipped vehicle and the determined location of the second target;
wherein the vehicular trailering assist system determines a triangle based on (i) the reference point at the equipped vehicle, (ii) the determined location of the first target and (iii) the determined location of the second target; and
wherein the vehicular trailering assist system, after completion of the calibration maneuver of the equipped vehicle, determines a trailer angle of the trailer relative to the equipped vehicle based at least on (i) the determined triangle, (ii) the determined first offset and (iii) the determined second offset.

2. The vehicular trailering assist system of claim 1, wherein the trailer comprises one selected from the group consisting of (i) a gooseneck trailer and (ii) a fifth wheel trailer.

3. The vehicular trailering assist system of claim 1, wherein the first target comprises a first adhesive sticker adhered to the trailer, and wherein the second target comprises a second adhesive sticker adhered to the trailer.

4. The vehicular trailering assist system of claim 1, wherein the vehicular trailering assist system determines the location of the first target disposed at the trailer and determines the location of the second target disposed at the trailer using a deep neural network.

5. The vehicular trailering assist system of claim 1, wherein the vehicular trailering assist system determines the location of the first target disposed at the trailer and determines the location of the second target disposed at the trailer based on converting pixel coordinates of the image data captured by the camera to world coordinates.

6. The vehicular trailering assist system of claim 1, wherein the calibration maneuver of the equipped vehicle comprises the equipped vehicle driving straight for at least a threshold distance.

7. The vehicular trailering assist system of claim 6, wherein the threshold distance is greater than ten meters.

8. The vehicular trailering assist system of claim 6, wherein the vehicular trailering assist system determines that the equipped vehicle has driven straight for at least the threshold distance based on kinematics of the equipped vehicle.

9. The vehicular trailering assist system of claim 1, wherein the vehicular trailering assist system, responsive to the determined location of the first target not being within a field of view of the camera, determines an updated trailer angle based on the determined location of the second target and the determined location of the first target in previously captured image data.

10. The vehicular trailering assist system of claim 1, wherein the first target comprises a pre-existing feature of the trailer, and wherein the second target comprises a pre-existing feature of the trailer.

11. The vehicular trailering assist system of claim 1, wherein the vehicular trailering assist system (i) determines a corrected midpoint on a line segment of the determined triangle connecting the determined location of the first target and the determined location of the second target, wherein the corrected midpoint is determined using the first offset and the second offset, (ii) determines a centerline extending between the reference point on the equipped vehicle and the determined corrected midpoint and (iii) determines the trailer angle based on an angle between the determined centerline and a longitudinal axis of the equipped vehicle.

12. The vehicular trailering assist system of claim 1, wherein the trailer comprises a receiver-hitch trailer, and wherein the reference point on the equipped vehicle comprises a center of a rear bumper of the equipped vehicle.

13. A vehicular trailering assist system, the vehicular trailering assist system comprising:
a camera disposed at a vehicle equipped with the vehicular trailering assist system, wherein the camera views exterior of the equipped vehicle, and wherein, with a trailer hitched to the equipped vehicle, the camera views at least a portion of the trailer hitched to the equipped vehicle;
wherein the camera is operable to capture image data;
an electronic control unit (ECU) comprising electronic circuitry and associated software;
wherein image data captured by the camera is transferred to the ECU;
wherein the electronic circuitry of the ECU comprises an image processor for processing image data captured by the camera and transferred to the ECU;
wherein the vehicular trailering assist system determines a reference point at the equipped vehicle that corresponds to a pivot axis of the trailer hitched to the equipped vehicle;
wherein the vehicular trailering assist system, via processing at the ECU of image data captured by the camera, (i) determines location of a first target disposed at the trailer and (ii) determines location of a second target disposed at the trailer;
wherein the vehicular trailering assist system, during a calibration maneuver of the equipped vehicle, (i) determines a first offset based on the location of the reference point at the equipped vehicle and the determined location of the first target and (ii) determines a second offset based on the location of the reference point at the equipped vehicle and the determined location of the second target;
wherein the calibration maneuver of the equipped vehicle comprises the equipped vehicle driving straight for at least a threshold distance;
wherein the vehicular trailering assist system determines a triangle based on (i) the reference point at the equipped vehicle, (ii) the determined location of the first target and (iii) the determined location of the second target;
wherein the vehicular trailering assist system (i) determines a corrected midpoint on a line segment of the determined triangle connecting the determined location of the first target and the determined location of the second target, wherein the corrected midpoint is determined using the first offset and the second offset and (ii) determines a centerline extending between the reference point on the equipped vehicle and the determined corrected midpoint; and
wherein the vehicular trailering assist system, after completion of the calibration maneuver of the equipped vehicle, determines a trailer angle of the trailer relative to the equipped vehicle based at least on an angle between the determined centerline and a longitudinal axis of the equipped vehicle.

14. The vehicular trailering assist system of claim 13, wherein the vehicular trailering assist system determines the location of the first target disposed at the trailer and determines the location of the second target disposed at the trailer using a deep neural network.

15. The vehicular trailering assist system of claim 13, wherein the vehicular trailering assist system, responsive to the determined location of the first target not being within a field of view of the camera, determines an updated trailer angle based on the determined location of the second target and the determined location of the first target in previously captured image data.

16. The vehicular trailering assist system of claim 13, wherein the first target comprises a pre-existing feature of the trailer, and wherein the second target comprises a pre-existing feature of the trailer.

17. A vehicular trailering assist system, the vehicular trailering assist system comprising:
a camera disposed at a vehicle equipped with the vehicular trailering assist system, wherein the camera views exterior of the equipped vehicle, and wherein, with a trailer hitched to the equipped vehicle, the camera views at least a portion of the trailer hitched to the equipped vehicle;
wherein the trailer comprises one selected from the group consisting of (i) a gooseneck trailer, (ii) a fifth wheel trailer and (iii) a receiver-hitch trailer;
wherein the camera is operable to capture image data;
an electronic control unit (ECU) comprising electronic circuitry and associated software;
wherein image data captured by the camera is transferred to the ECU;
wherein the electronic circuitry of the ECU comprises an image processor for processing image data captured by the camera and transferred to the ECU;
wherein the vehicular trailering assist system determines a reference point at the equipped vehicle that corresponds to a pivot axis of the trailer hitched to the equipped vehicle;
wherein the vehicular trailering assist system, via processing at the ECU of image data captured by the camera, (i) determines location of a first target disposed at the trailer and (ii) determines location of a second target disposed at the trailer;
wherein the vehicular trailering assist system, during a calibration maneuver of the equipped vehicle, (i) determines a first offset based on the location of the reference point at the equipped vehicle and the determined location of the first target and (ii) determines a second offset based on the location of the reference point at the equipped vehicle and the determined location of the second target;
wherein the vehicular trailering assist system determines a triangle based on (i) the reference point at the equipped vehicle, (ii) the determined location of the first target and (iii) the determined location of the second target;
wherein the vehicular trailering assist system, after completion of the calibration maneuver of the equipped vehicle, determines a trailer angle of the trailer relative to the equipped vehicle based at least on (i) the determined triangle, (ii) the determined first offset and (iii) the determined second offset; and
wherein the vehicular trailering assist system, responsive to the determined location of the first target not being within a field of view of the camera, determines an updated trailer angle based on the determined location of the second target and the determined location of the first target in previously captured image data.

18. The vehicular trailering assist system of claim 17, wherein the vehicular trailering assist system determines the location of the first target disposed at the trailer and determines the location of the second target disposed at the trailer based on converting pixel coordinates of the image data captured by the camera to world coordinates.

19. The vehicular trailering assist system of claim 17, wherein the vehicular trailering assist system determines the location of the first target disposed at the trailer and determines the location of the second target disposed at the trailer using a deep neural network.

20. The vehicular trailering assist system of claim 17, wherein the calibration maneuver of the equipped vehicle comprises the equipped vehicle driving straight for at least a threshold distance, and wherein the threshold distance is greater than ten meters.
